(19) United States
(12) Patent Application Publication
(10) Pub. No.: US 2026/0186694 A1
(43) Pub. Date: Jul. 2, 2026

(54) MEMORY MANAGEMENT METHOD AND MEMORY CONTROLLER

(71) Applicant: XIAMEN HOSIN GLOBAL ELECTRONICS CO., LTD, Fujian (CN)

(72) Inventors: Jie Su, Fujian (CN); Zhi Chao Su, Fujian (CN); Ming Yen Li, Fujian (CN); MINYAN CIOU, Fujian (CN); Huangzheng Lai, Fujian (CN); Bingxin Ye, Fujian (CN)

(73) Assignee: XIAMEN HOSIN GLOBAL ELECTRONICS CO., LTD, Fujian (CN)

(21) Appl. No.: 19/425,998

(22) Filed: Dec. 18, 2025

(30) Foreign Application Priority Data
Dec. 27, 2024 (CN) 202411952796.0

(51) Int. Cl. G06F 3/06

(52) U.S. Cl. CPC G06F 3/0655; G06F 3/0604; G06F 3/0679

(57) ABSTRACT

The present disclosure provides a memory management method and a memory controller thereof. The method includes: obtaining a first voltage value of a first data read operation; setting the first voltage value and a first read parameter to an integrated read module; while the integrated read module executes the first data read operation, obtaining in parallel a second voltage value of a second data read operation; and in response to completion of the first data read operation, setting the second voltage value and a second read parameter to the integrated read module to execute the second data read operation. The present disclosure significantly improves the data read efficiency of a storage device during an error handling process by integrating read steps and implementing parallel processing.

### CROSS-REFERENCE TO RELATED APPLICATION

This application claims the priority benefit of China application serial no. 202411952796.0, filed on Dec. 27, 2024. The entirety of the above-mentioned patent application is hereby incorporated by reference herein and made a part of this specification.

### BACKGROUND

### Technical Field

The present disclosure relates to the field of memory technology, and more particularly, to a memory management method and a memory controller thereof.

### Description of Related Art

In modern storage technology, rewritable non-volatile memory (NAND Flash) has been widely used in storage devices such as solid state drives (SSDs). During the operation of the storage device, data read errors may occur, and in this case, an error handling (Error Handle) mechanism is required to ensure the correct reading of data.

In a traditional error handling process, the firmware needs to perform special processing on data where an error has occurred, wherein an important step is to adjust the read voltage of the NAND Flash, so as to ensure that correct data can be read. However, this process involves a plurality of steps, including setting a voltage value, checking whether the set voltage value is correct, reading raw data on the NAND Flash, and transmitting data. These steps are not only cumbersome to operate, but also consume a lot of time during execution, so as to affect the overall read/write performance of the storage device.

### SUMMARY

The present disclosure provides a memory management method and a memory controller thereof to solve the technical problem in the prior art that the error handling process is time-consuming.

One or more embodiments of the present invention provide a memory management method, adapted for a storage device configured with a rewritable non-volatile memory module. The method comprises: obtaining a first voltage value of a first data read operation corresponding to first data; setting the first voltage value and a first read parameter corresponding to the first data to an integrated read module, so as to execute the first data read operation via the integrated read module; while executing the first data read operation, obtaining in parallel a second voltage value of a second data read operation corresponding to second data; and in response to completion of the first data read operation, setting the second voltage value and a second read parameter corresponding to the second data to the integrated read module, so as to execute the second data read operation via the integrated read module.

One or more embodiments of the present invention provide a memory controller for controlling a storage device configured with a rewritable non-volatile memory module. The memory controller comprises: a memory interface control circuit, for electrically connecting to the rewritable non-volatile memory module; and a processor, electrically connected to the memory interface control circuit, wherein the processor is further electrically connected to a connection interface circuit of the storage device, so as to be electrically connected to a host system. Wherein, the processor is configured to: obtain a first voltage value of a first data read operation corresponding to first data; set the first voltage value and a first read parameter corresponding to the first data to an integrated read module, so as to execute the first data read operation via the integrated read module; when the integrated read module executes the first data read operation, obtain in parallel a second voltage value of a second data read operation corresponding to second data; and in response to completion of the first data read operation, set the second voltage value and a second read parameter corresponding to the second data to the integrated read module, so as to execute the second data read operation via the integrated read module.

Based on the above, the memory management method provided by the present disclosure effectively reduces the time for the firmware to execute redundant code by integrating a plurality of conventional read steps into a unified interface. Meanwhile, by calculating in parallel the voltage value required for the next read operation while executing the current data read operation, parallel processing of the data read process is realized, the data read efficiency in the error handling process is optimized, so as to enhance the working efficiency of the storage device.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic block diagram of a host system and a storage device according to an embodiment of the present invention.

FIG. 2 is a flowchart of a memory management method according to an embodiment of the present disclosure.

FIG. 3 is a schematic diagram of an integrated read module according to an embodiment of the present disclosure.

FIG. 4 is a sequence diagram of a data read operation between a processor, an integrated read module, and a rewritable non-volatile memory module according to an embodiment of the present disclosure.

FIG. 5 is a schematic timing diagram of a plurality of data read operations according to an embodiment of the present disclosure.

FIG. 6 is a schematic timing diagram of a plurality of data read operations according to another embodiment of the present disclosure.

FIG. 7 is a schematic timing diagram of a plurality of data read operations according to yet another embodiment of the present disclosure.

### DESCRIPTION OF THE EMBODIMENTS

Reference will now be made in detail to the exemplary embodiments of the present invention, examples of which are illustrated in the accompanying drawings. Wherever possible, the same reference numerals are used in the drawings and the description to refer to the same or like parts.

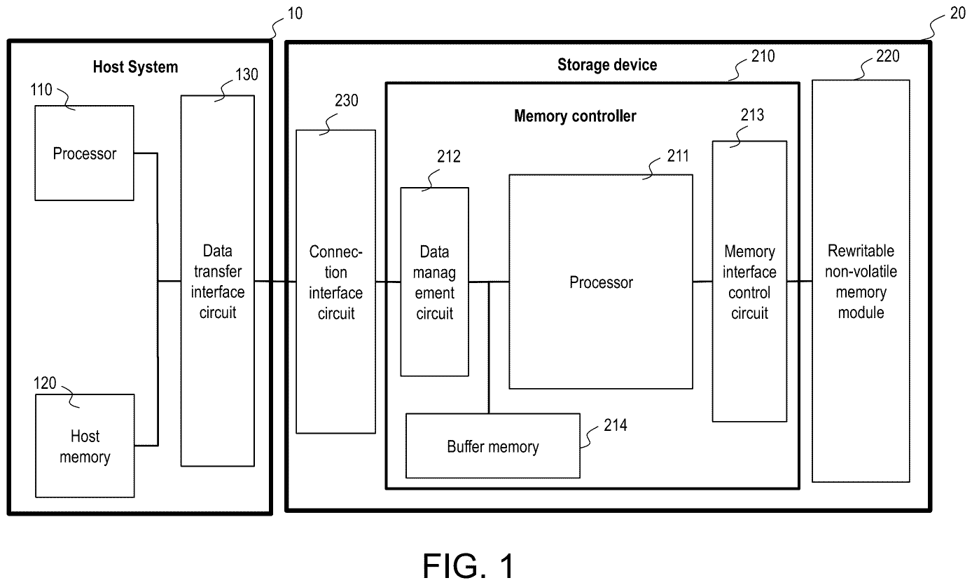

FIG. 1 is a schematic block diagram of a host system and a storage device according to an embodiment of the present invention. Referring to FIG. 1, the host system 10 is, for example, a personal computer, a notebook computer, or a server. The host system (Host System) 10 comprises a processor (Processor) 110 (also referred to as a second processor), a host memory (Host Memory) 120, and a data transfer interface circuit (Data Transfer Interface Circuit) 130. In this embodiment, the processor 110 is coupled (also referred to as electrically connected) to the host memory 120 and the data transfer interface circuit 130. In another embodiment, the processor (Processor) 110, the host memory 120, and the data transfer interface circuit 130 are electrically connected to each other via a system bus (System Bus). In this embodiment, the processor 110, the host memory 120, and the data transfer interface circuit 130 may be disposed on a motherboard of the host system 10.

The storage device 20 comprises a memory controller (also referred to as the storage controller) 210, a rewritable non-volatile memory module (Rewritable Non-Volatile Memory Module) 220, and a connection interface circuit (Connection Interface Circuit) 230. Wherein, the memory controller 210 comprises a processor 211 (also referred to as a first processor), a data management circuit (Data Management Circuit) 212, and a memory interface control circuit (Memory Interface Control Circuit) 213.

In this embodiment, the host system 10 is electrically connected to the storage device 20 via the data transfer interface circuit 130 and the connection interface circuit 230 of the storage device 20 to perform data access operations. For example, the host system 10 may store data to the storage device 20 or read data from the storage device 20 via the data transfer interface circuit 130.

In this embodiment, the number of the data transfer interface circuits 130 may be one or a plurality. Through the data transfer interface circuit 130, a motherboard may be electrically connected to the storage device 20 via a wired or wireless manner. The storage device 20 may be, for example, a USB flash drive, a memory card, a solid state drive (SSD), or a wireless memory storage device. The wireless memory storage device may be, for example, a Near Field Communication (NFC) memory storage device, a Wi-Fi memory storage device, a Bluetooth memory storage device, or a low-power Bluetooth memory storage device (e.g., iBeacon), or other memory storage devices based on various wireless communication technologies. In addition, the motherboard may also be electrically connected to various I/O devices such as a Global Positioning System (GPS) module, a network interface card, a wireless transmission device, a keyboard, a screen, a speaker, etc., through the system bus.

In this embodiment, the data transfer interface circuit 130 and the connection interface circuit 230 are interface circuits compatible with the Peripheral Component Interconnect Express (PCI Express) standard. Moreover, data transmission between the data transfer interface circuit 130 and the connection interface circuit 230 utilizes the Non-Volatile Memory express (NVMe) communication protocol.

In addition, in another embodiment, the connection interface circuit 230 may be packaged together in a single chip with the memory controller 210, or the connection interface circuit 230 is disposed outside a chip containing the memory controller 210.

In this embodiment, the host memory 120 is configured to temporarily store instructions or data executed by the processor 110. For example, in this embodiment, the host memory 120 may be a dynamic random access memory (DRAM), a static random access memory (SRAM), or the like. However, it should be understood that the present invention is not limited thereto, and the host memory 120 may also be other suitable memories.

The memory controller 210 is configured to execute a plurality of logic gates or control instructions implemented in the form of hardware or firmware and perform operations such as writing, reading, and erasing of data in the rewritable non-volatile memory module 220 according to instructions from the host system 10.

In more detail, the processor 211 in the memory controller 210 is hardware with computing capabilities, which is configured to control the overall operation of the memory controller 210. Specifically, the processor 211 is programmed by a plurality of control instructions/program codes, and when the storage device 20 operates, these control instructions/program codes are executed to perform operations such as writing, reading, and erasing of data. In addition, in this embodiment, the control instructions/program codes may be further executed to perform a data read operation, so as to implement the memory management method for an error handling procedure provided by the present invention. The control instructions/program codes corresponding to the memory management method may be further implemented as circuit units in a hardware form, so as to implement the memory management method provided by the present invention.

It is worth mentioning that, in this embodiment, the processor 110 and the processor 211 are, for example, a central processing unit (CPU), a microprocessor, or other programmable processing units (Microprocessor), a digital signal processor (DSP), a programmable controller, an application specific integrated circuit (ASIC), a programmable logic device (PLD), or other similar circuit components, and the present invention is not limited thereto.

In this embodiment, as described above, the memory controller 210 further comprises the data management circuit 212 and the memory interface control circuit 213. It should be noted that operations performed by various components of the memory controller 210 may also be regarded as operations performed by the memory controller 210.

Wherein, the data management circuit 212 is electrically connected to the processor 211, the memory interface control circuit 213, and the connection interface circuit 230. The data management circuit 212 is configured to receive instructions from the processor 211 to perform data transmission. For example, reading data from the host system 10 (e.g., the host memory 120) via the connection interface circuit 230, and writing the read data to the rewritable non-volatile memory module 220 via the memory interface control circuit 213 (e.g., performing a write operation according to a write command from the host system 10). As another example, reading data from one or more physical units of the rewritable non-volatile memory module 220 via the memory interface control circuit 213 (data may be read from one or more storage units in the one or the plurality of physical units), and writing the read data to the host system 10 (e.g., the host memory 120) via the connection interface circuit 230 (e.g., performing a read operation according to a read command from the host system 10). In another embodiment, the data management circuit 212 may also be integrated into the processor 211.

The memory interface control circuit 213 is configured to receive instructions from the processor 211 and, in coordination with the data management circuit 212, to perform write (also referred to as programming), read, or erase operations on the rewritable non-volatile memory module 220.

In addition, data to be written to the rewritable non-volatile memory module 220 is converted via the memory interface control circuit 213 into a format acceptable to the rewritable non-volatile memory module 220. Specifically, if the processor 211 is to access the rewritable non-volatile memory module 220, the processor 211 sends a corresponding command sequence to the memory interface control circuit 213 to instruct the memory interface control circuit 213 to perform a corresponding operation. For example, these command sequences may comprise a write command sequence for instructing to write data, a read command sequence for instructing to read data, an erase command sequence for instructing to erase data, and corresponding command sequences for instructing various memory operations. These command sequences may comprise one or more signals, or data on a bus. These signals or data may comprise instruction codes or program codes. For example, the read command sequence will comprise information such as a read identifier, a memory address, and a physical address.

In addition, the memory controller 210 establishes a logical-to-physical address mapping table and a physical-to-logical address mapping table to record the mapping relationship between logical addresses of logical units (e.g., logical blocks, logical pages) configured for the rewritable non-volatile memory module 220 and physical addresses of physical units (e.g., physical erase units/physical blocks, physical pages). In other words, the memory controller 210 may look up a physical unit to which a logical unit is mapped (e.g., look up a physical page to which a logical page is mapped; look up a physical address to which a logical address is mapped) through the logical-to-physical address mapping table (also referred to as a logical-to-physical mapping table), and the memory controller 210 may look up a logical unit to which a physical unit is mapped (e.g., look up a logical page to which a physical page is mapped; look up a logical address to which a physical address is mapped) through the physical-to-logical address mapping table (also referred to as a physical-to-logical mapping table).

In an embodiment, the memory controller 210 further comprises a buffer memory 214. The buffer memory is electrically connected to the processor 211 and is configured to temporarily store data and instructions from the host system 10, data from the rewritable non-volatile memory module 220, or other system data for managing the storage device 20 (e.g., various mapping tables, a voltage adjustment level list, a read voltage list, read results), so as to allow the processor 211 to quickly access the data, instructions, or system data from the buffer memory 214.

The rewritable non-volatile memory module 220 is electrically connected to the memory controller 210 (the memory interface control circuit 213) and is configured to store user data sent by the host system 10.

In this embodiment, each of a plurality of memory dies (chips) of the rewritable non-volatile memory module 220 has a plurality of planes, and each of the planes has a plurality of physical blocks. Each physical block comprises a plurality of physical programming units (also referred to as physical pages). Each physical page has a plurality of storage units (also referred to as physical bytes or bytes), and each storage unit corresponds to a physical address. The physical address is configured to record the physical location of data stored in the storage units. It should be noted that the present invention is not limited to the size of each physical page and logical page. The size of each byte is 8 bits, used to store 8 bit values of data.

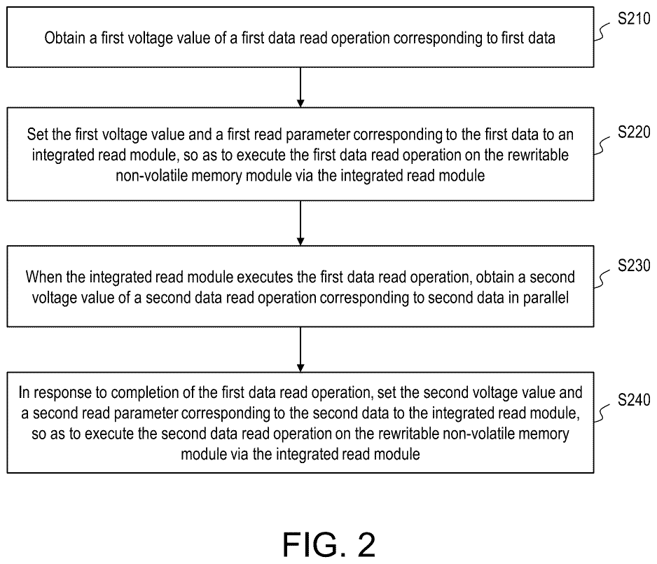

FIG. 2 is a flowchart of a memory management method according to an embodiment of the present disclosure.

In an embodiment, referring to FIG. 2, in step S210, the memory controller 210 obtains a first voltage value of a first data read operation corresponding to first data.

Specifically, when the storage device 20 needs to read data, the memory controller 210 first determines a first voltage value required for reading the first data. The first voltage value may be obtained through algorithm calculation and is configured to ensure that data is correctly read from the rewritable non-volatile memory module 220.

Next, in step S220, the memory controller 210 sets the first voltage value and a first read parameter corresponding to the first data to an integrated read module, so as to execute the first data read operation on the rewritable non-volatile memory module 220 via the integrated read module.

Wherein, the first read parameter may comprise a target physical address of the first data in the rewritable non-volatile memory module 220, a first data length of the first data, physical page size information of the first data, a read mode identifier of the first data, an error detection parameter of the first data, and metadata of the first data.

In an embodiment, the memory controller 210 may flexibly configure the specific content of the first read parameter according to different application scenarios and read requirements.

Specifically, the target physical address is configured to precisely locate the storage position of the first data in the rewritable non-volatile memory module 220, ensuring that the read operation can access the correct data area. The first data length parameter indicates the amount of data to be read, enabling the memory controller 210 to accurately allocate the buffer space required for the read operation. The physical page size information reflects the physical storage characteristics of the rewritable non-volatile memory module 220, which helps the memory controller 210 to optimize the data read strategy. The read mode identifier is configured to indicate a specific mode of the current read operation, for example, whether an error check is required or whether it is a continuous read mode. The error detection parameter comprises verification information for ensuring data integrity, enabling the memory controller 210 to timely discover and handle possible data errors. In addition, the metadata may further comprise auxiliary information such as a timestamp and access permissions of the data, and this information has a corresponding role for various data management and read control.

Next, in step S230, when the integrated read module executes the first data read operation, the memory controller 210 obtains in parallel a second voltage value of a second data read operation corresponding to second data.

Thus, through this parallel processing mechanism, the memory controller 210, while executing the current read operation, has already started preparing the voltage value required for the next read operation, so as to improve the data read efficiency.

In an embodiment, the memory controller 210 triggering the integrated read module to execute the first data read operation may be based on a plurality of conditions. For example, when the host system 10 sends a read request, the memory controller 210 checks the priority and urgency of the request. If it is a high-priority request, the memory controller 210 immediately triggers the integrated read module to execute the read operation. In addition, when the memory controller 210 detects that data in the rewritable non-volatile memory module 220 may have a risk of bit flip, it also actively triggers a read operation to ensure the integrity of the data. Alternatively, when performing maintenance tasks such as data verification, the memory controller 210 may also need to trigger the integrated read module to execute a read operation. It is worth mentioning that, after receiving a trigger signal, the integrated read module first verifies whether the set parameters are valid to ensure that the read operation can proceed normally.

Then, in step S240, in response to completion of the first data read operation, the memory controller 210 sets the second voltage value and a second read parameter corresponding to the second data to the integrated read module, so as to execute the second data read operation on the rewritable non-volatile memory module 220 via the integrated read module.

It is worth mentioning that, in this embodiment, the memory controller 210 significantly reduces the time for the firmware to execute redundant code by integrating a plurality of conventional read steps into a unified interface and adopting a parallel processing mechanism. In addition, since the necessary parameters for the second data read operation are already prepared during the execution of the first data read operation, the second data read operation can be started immediately after the first data read operation is completed, further optimizing the overall read process.

In addition, in a specific implementation of this embodiment, the memory controller 210 may determine whether to continue executing the second data read operation by monitoring the execution status of the first data read operation. If the first data read operation fails, the memory controller 210 may need to use a different voltage value to re-execute the first data read operation, and in which case the execution of the second data read operation may be paused.

In an embodiment, when the memory controller 210 executes a read operation through the integrated read module, it monitors the execution status of various operations in real time. If it is detected that the first data read operation fails, the memory controller 210 immediately starts a data recovery mechanism.

Specifically, the memory controller 210 first obtains another first voltage value for rereading the first data according to a preset voltage adjustment algorithm. This another first voltage value is different from the previously used first voltage value and is usually adjusted appropriately according to the cause of failure, so as to increase the probability of successful reading.

In more detail, after obtaining the another first voltage value, the memory controller 210 sets the voltage value together with the original first read parameters to the integrated read module. These first read parameters, including information such as the target physical address, remain unchanged because the read target is still the same first data. Subsequently, the memory controller 210 re-executes the first data read operation via the integrated read module.

It is worth mentioning that, in an embodiment, during this rereading process, the memory controller 210 simultaneously manages the execution status of the second data read operation. Since the failure of the first data read operation may imply that there is a potential data integrity issue, the memory controller 210 pauses the execution of the second data read operation.

Thus, through the aforementioned pause mechanism, the memory controller starts executing the read operation of the second data when it is confirmed that the first data read operation is successfully completed, so as to ensure the reliability and accuracy of data reading. Only after confirming that the first data has been successfully read, the memory controller 210 resumes the execution of the second data read operation. This strategy not only can effectively prevent the spread of errors, but also can ensure the orderly execution of data read operations.

In some embodiments, the memory controller 210 may set a maximum number of retries to avoid getting into an infinite retry loop in some extreme cases. In addition, the voltage value used for each retry may follow a specific adjustment pattern, such as gradually increasing or decreasing, to improve retry efficiency.

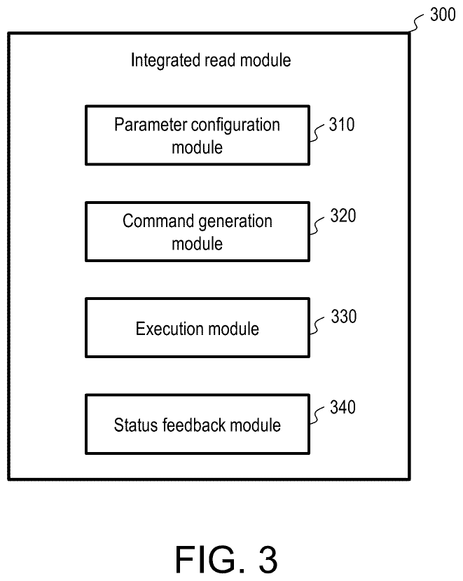

FIG. 3 is a schematic diagram of an integrated read module according to an embodiment of the present disclosure.

In an embodiment, referring to FIG. 3, the integrated read module 300 is configured to execute data read commands issued by the memory controller 210. The integrated read module 300 comprises a parameter configuration module 310, a command generation module 320, an execution module 330, and a status feedback module 340.

Specifically, in an embodiment, the parameter configuration module 310 is configured to store various read parameters received from the memory controller 210. These parameters comprise a first voltage value and a first read parameter, wherein the first read parameter may comprise a target physical address, a data length, physical page size information, a read mode identifier, an error detection parameter, and metadata. The parameter configuration module 310 performs unified management and storage of these parameters to provide necessary configuration information for subsequent read operations.

In an embodiment, the command generation module 320 generates a read command sequence for the rewritable non-volatile memory module 220 according to the parameter information stored in the parameter configuration module 310. These command sequences comprise complete read operation instructions, for example, a command for setting a read voltage value, a command for executing data reading, and a command for data transmission. The command generation module 320 ensures that the generated command sequence complies with the communication protocol requirements of the rewritable non-volatile memory module 220.

In an embodiment, the execution module 330 is responsible for sending the read command sequence generated by the command generation module 320 to the rewritable non-volatile memory module 220, and receiving data returned from the rewritable non-volatile memory module 220. The execution module 330 manages the entire data transmission process, ensuring the correct execution of commands and the reliable transmission of data.

In an embodiment, the status feedback module 340 is configured to store execution status information of the read operation, including status information such as whether the operation is successfully completed and whether an error has occurred. This status information is timely fed back to the memory controller 210, so that it can timely understand the execution situation of the read operation and take corresponding processing measures.

In another embodiment, the memory controller 210 may take corresponding processing measures according to different execution statuses fed back by the status feedback module 340. Specifically, when the status feedback module 340 reports that the first data read operation has failed, the memory controller 210 may take the following processing measures: first, the memory controller 210 analyzes the cause of the failure, for example, checking whether the data read error is caused by an inappropriate read voltage value. If it is confirmed that the problem is with the voltage value, the memory controller 210 selects another voltage value from the voltage adjustment level list in the buffer memory 214 and re-executes the read operation via the integrated read module 300.

In more detail, if the status feedback module 340 reports that reading has failed multiple consecutive times using different voltage values, the memory controller 210 may start a more complex error recovery mechanism. For example, the memory controller 210 may record all attempted voltage values and their corresponding read results, and determine the optimal read voltage value by analyzing this data. At the same time, the memory controller 210 may also update the voltage adjustment level list in the buffer memory 214, adding newly discovered effective voltage values to the list to optimize future read operations.

In addition, when the status feedback module 340 reports that read errors occur frequently in a certain storage area, the memory controller 210 may record this information in the buffer memory 214 to evaluate the reliability of the storage area (e.g., error frequency). If the error frequency exceeds a preset threshold, the memory controller 210 may initiate a data migration operation to transfer the data stored in this area to a more reliable storage area, so as to prevent possible data loss.

It is worth mentioning that the memory controller 210 also optimizes the parallel processing strategy according to the report from the status feedback module 340. For example, when it is found that certain specific types of read errors occur regularly, the memory controller 210 may adjust the scheduling strategy of parallel read operations to avoid executing parallel operations in these error-prone situations, so as to improve the overall read reliability.

It is worth mentioning that this modular design of the integrated read module 300 not only improves the maintainability of the code, but also realizes standardized processing of read operations. By integrating a plurality of read steps into a unified interface, the operation process of the memory controller 210 is simplified, and at the same time, the efficiency of data reading is improved. In addition, this design also supports a parallel processing mechanism, allowing the parameters for the next read operation to be prepared while the current read operation is being executed.

In some embodiments, the various sub-modules of the integrated read module 300 communicate with each other through standardized internal interfaces, and this design makes the upgrade and maintenance of the modules easier. For example, when it is necessary to support a new read mode or optimize a specific type of read operation, modifications only need to be made in the corresponding sub-module without affecting the normal operation of other modules.

In another embodiment, the integrated read module 300 achieves efficient data read operations through synergistic work with various components of the storage device 20.

Specifically, after receiving a read command from the memory controller 210, the parameter configuration module 310 obtains various required parameters from the buffer memory 214. For example, when a data read operation for error handling needs to be executed, the parameter configuration module 310 first reads the voltage adjustment level list from the buffer memory 214 to determine an appropriate read voltage value. At the same time, the parameter configuration module 310 also obtains the physical address information of the target data through the logical-to-physical address mapping table of the memory controller 210, so as to ensure accurate positioning of the data to be read.

In some embodiments, the command generation module 320, according to the information provided by the parameter configuration module 310 and in coordination with the memory interface control circuit 213, generates a command sequence that complies with the communication protocol of the rewritable non-volatile memory module 220. For example, when the read voltage value needs to be adjusted, the command generation module 320 generates a complete sequence comprising a voltage setting command, a voltage verification command, and a data read command. These command sequences are format-converted via the memory interface control circuit 213 to ensure that the rewritable non-volatile memory module 220 can correctly recognize and execute them.

In some embodiments, during the data transmission phase, the execution module 330 coordinates the data transmission process through the data management circuit 212. After the execution module 330 sends a read command sequence, the data management circuit 212 is responsible for managing the flow of data read from the rewritable non-volatile memory module 220. For example, during an error handling process, if the same data needs to be read multiple times using different voltage values, the execution module 330, in coordination with the data management circuit 212, temporarily stores the data read each time in the buffer memory 214 for subsequent data comparison and analysis.

In some embodiments, the status feedback module 340 maintains real-time status communication with the processor 211. After the execution module 330 completes a read operation, the status feedback module 340 records the execution result in the read result list of the buffer memory 214. By checking this status information, the processor 211 can timely determine whether the read operation needs to be re-executed with an adjusted voltage value. For example, if the status feedback module 340 reports that the read operation has failed, the processor 211 immediately obtains a new voltage value from the buffer memory 214 and starts a new round of read operation via the parameter configuration module 310.

It is worth mentioning that this modular design allows the integrated read module 300 to make full use of the functions of various components of the storage device 20, while simplifying the operation process through a unified interface. For example, when processing an error handling request, the processor 211 only needs to send a read command to the integrated read module 300, and subsequent complex operations such as parameter acquisition, command generation, and data transmission are all completed in coordination by the various sub-modules of the integrated read module 300, which greatly reduces the burden on the processor 211.

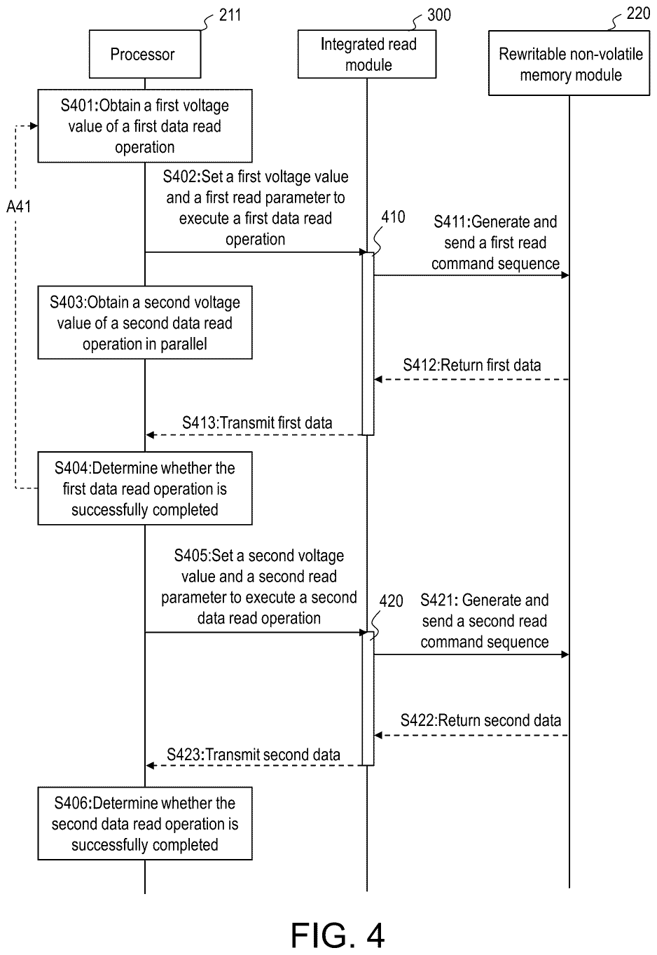

FIG. 4 is a sequence diagram of a data read operation between a processor, an integrated read module, and a rewritable non-volatile memory module according to an embodiment of the present disclosure.

In an embodiment, referring to FIG. 4, the figure shows the interaction timing between the processor 211, the integrated read module 300, and the rewritable non-volatile memory module 220 during a data read operation.

Specifically, in step S401, the processor 211 first obtains a first voltage value of a first data read operation. Next, in step S402, the processor 211 sets the first voltage value and a first read parameter to the integrated read module 300 to execute a first data read operation (S410). While executing the first data read operation, the processor 211 obtains in parallel a second voltage value of a second data read operation in step S403, which reflects the parallel processing mechanism of the present disclosure.

In another embodiment, when executing steps S402 and S403, the processor 211 adopts a specific processing mechanism to optimize the data read operation. Specifically, in step S402, the processor 211 first obtains configuration information of the first read parameter from the buffer memory 214. This configuration information comprises a target physical address of the first data in the rewritable non-volatile memory module 220, a length of the first data, page size information, a read mode identifier, an error detection parameter, and metadata. The processor 211 transmits these parameters together with the obtained first voltage value to the parameter configuration module 310 of the integrated read module 300 for unified configuration. At the same time, the processor 211 marks the status of these parameters in the buffer memory 214 in order to subsequently track the execution of the read operation.

When executing step S403, the processor 211 immediately starts the calculation process of the second voltage value without waiting for the completion of the first data read operation. More specifically, the processor 211 determines a suitable voltage value for the second data read operation according to a preset voltage adjustment algorithm, in combination with the voltage adjustment level list stored in the buffer memory 214. This parallel processing mechanism enables the processor 211 to make full use of the execution time of the first data read operation to prepare in advance key parameters (e.g., the second voltage value) required for the second data read operation.

Next, after receiving the setting from the processor 211, the integrated read module 300 triggers and executes a first data read operation S410. Subsequently, in step S411, the integrated read module 300 generates and sends a first read command sequence to the rewritable non-volatile memory module 220. The rewritable non-volatile memory module 220 executes a corresponding read operation and returns first data in step S412. After receiving the data, the integrated read module 300 transmits the first data to the processor 211 in step S413.

In another embodiment, when the integrated read module 300 executes steps S411 to S413, it completes the data read operation through the synergistic work of its various internal functional modules. Specifically, in step S411, the command generation module 320 first generates a complete first read command sequence according to the first voltage value and the first read parameter stored in the parameter configuration module 310. This command sequence comprises a plurality of specific operation instructions such as a command for setting a voltage value, a command for verifying a voltage value, and a command for reading data. Subsequently, the execution module 330 sends these command sequences to the rewritable non-volatile memory module 220 according to a specific timing. In step S412, after the rewritable non-volatile memory module 220 completes data reading, the execution module 330 is responsible for receiving the returned first data. The execution module 330 performs a preliminary integrity verification on the received data to ensure that no errors occurred during the data transmission process. At the same time, the status feedback module 340 records the status information of data reception in real time for the processor 211 to refer to.

In step S413, the execution module 330 transmits the verified first data to the processor 211, and at the same time, the status feedback module 340 may generate a detailed operation status report, which comprises the complete execution of the read operation, the data transmission status, and any abnormal situations that may occur. This information is transmitted together to the processor 211, enabling it to timely understand the execution result of the read operation and decide on subsequent operations.

In another embodiment, the verification of the first data by the execution module 330 comprises multiple levels. Specifically, the execution module 330 first checks the integrity of the data, ensuring that the data is not damaged or lost during the transmission process through mechanisms such as checksum. In addition, the execution module 330 also verifies whether the format of the data meets expectations, including whether the data length is correct and whether the data structure is complete. If any abnormality is found, the execution module 330 immediately reports an error status to the processor 211 via the status feedback module 340.

Next, in step S404, the processor 211 determines whether the first data read operation is successfully completed.

If the first data read operation is successfully completed, the processor 211 then sets a second voltage value and a second read parameter to the integrated read module 300 in step S405 to execute a second data read operation. The integrated read module 300 subsequently starts the second data read operation in step S420, and generates and sends a second read command sequence to the rewritable non-volatile memory module 220 in step S421. After executing the read operation, the rewritable non-volatile memory module 220 returns second data via step S422, and the integrated read module 300 then transmits the second data to the processor 211 in step S423. Finally, in step S406, the processor 211 determines whether the second data read operation is successfully completed.

In another embodiment, the memory controller 210 implements a complete voltage value optimization mechanism. Specifically, when the memory controller 210 executes a plurality of read operations for the first data, the processor 211 stores the first voltage value used each time and its corresponding read result in the buffer memory 214. These read results comprise detailed data correctness information, for example, the number of error bits detected in each read operation.

In more detail, the processor 211 establishes a voltage value performance table to record each attempted first voltage value and its corresponding number of read error bits. For example, 50 error bits may be detected when using voltage value V1, 30 error bits are detected when using voltage value V2, and 20 error bits are detected when using voltage value V3. By analyzing this data, the processor 211 determines the voltage value that produces the minimum number of error bits as the optimal voltage value.

In practical applications, the processor 211 may perform multiple rounds of testing to ensure the reliability of the results. For example, a plurality of read operations may be performed for each voltage value, and the influence of random factors is reduced by taking the average number of error bits. In addition, the processor 211 also stores the determined optimal voltage value in the buffer memory 214 to form a voltage optimization database. This database not only records the specific voltage value, but also comprises corresponding usage scenario information, such as the storage area where the data is located and the temperature conditions during reading, to provide a reference for subsequent read operations.

It is worth mentioning that, when determining the optimal voltage value, the memory controller 210 also considers the stability of the read operation. Specifically, if a certain voltage value produces the minimum number of error bits in a certain read, but the results of multiple tests fluctuate greatly, the processor 211 may select a voltage value with a more stable overall performance as the optimal voltage value. This strategy ensures that the read operation can maintain a high level of reliability under different conditions.

In some embodiments, the processor 211 may periodically update the voltage optimization database to adapt to performance changes of the storage device during use. For example, when it is found that the optimal voltage value of a certain storage area begins to deviate from historical records, a new round of voltage value optimization process may be triggered.

In some embodiments, the processor 211 may dynamically adjust the parameters of the second data read operation according to the execution status of the first data read operation. For example, if it is found that the first data read operation has a higher success rate at a certain specific voltage value, the processor 211 may adjust the second voltage value accordingly to improve the success rate of the second data read operation.

In another embodiment, referring to FIG. 4, as shown by arrow A41, the processor 211 further executes an iterative data read process. Specifically, when the processor 211 determines in step S404 that the first data read operation is not successfully completed, the processor 211 starts an iterative read mechanism. In this case, the processor 211 re-executes step S401 to obtain another first voltage value, and, via step S402, again sets the voltage value and the first read parameter to the integrated read module 300 to attempt to reread the first data. This iterative process may continue until the first data is successfully read or a preset retry limit is reached.

In more detail, the processor 211 may select another first voltage value based on different strategies. For example, the processor 211 may calculate a new voltage value through a preset voltage adjustment algorithm according to the result of the previous read operation. Alternatively, the processor 211 may also select the next voltage value to be tried from a pre-stored voltage value sequence in the buffer memory 214. This iterative read mechanism ensures that in the event that the first read fails, there is still an opportunity to successfully read the data by adjusting the voltage value.

However, in yet another embodiment, even if the first data read operation has been successfully completed, under specific conditions, the processor 211 may still continue to execute additional read operations. For example, when the processor 211 detects that the number of error bits in the current read result is close to an acceptable upper limit, even if the data can already be successfully corrected, the processor 211 may choose to use another voltage value to perform an additional read attempt, in order to obtain a higher-quality read result. This optimization mechanism is particularly suitable for application scenarios with high requirements for data reliability.

It is worth mentioning that, when executing these additional read operations, the processor 211 balances the improvement in read quality with the time overhead. For example, if the number of error bits in the current read result is already low, or the system is in a high-load state, the processor 211 may choose to skip the additional read attempt and directly proceed the read operation of the next data. This flexible strategy enables the memory controller 210 to achieve a good balance between read performance and data reliability.

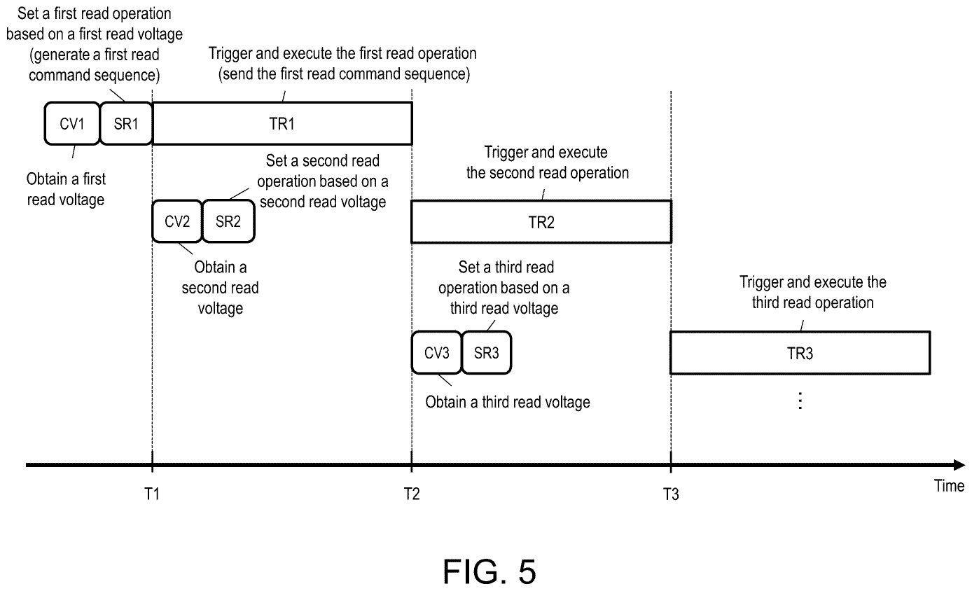

FIG. 5 is a schematic timing diagram of a plurality of data read operations according to an embodiment of the present disclosure.

In an embodiment, referring to FIG. 5, the figure shows a timing flow of the memory controller 210 executing a plurality of data read operations.

For example, at time point T1, the memory controller 210 first executes step CV1 corresponding to the first data: obtaining a first read voltage (also referred to as a first voltage value). Subsequently, in step SR1, a first read operation corresponding to the first data is set based on the first read voltage. Immediately thereafter, the memory controller 210 triggers and executes a first read operation TR1. It is worth noting that, during the execution of the first read operation TR1, the memory controller 210 starts to execute step CV2 of obtaining a second read voltage (also referred to as a second voltage value) corresponding to second data, and in step SR2, sets a second read operation corresponding to the second data based on the second read voltage, which reflects the parallel processing mechanism of the present disclosure.

In more detail, when time point T2 is reached, the first read operation TR1 is completed, and the memory controller 210 immediately triggers and executes a second read operation TR2. At the same time, the memory controller 210 further executes step CV3 of obtaining a third read voltage (also referred to as a third voltage value) corresponding to third data, and in step SR3, sets a third read operation corresponding to the third data based on the third read voltage. This design ensures that at any time, a subsequent read operation can be executed following the previous read operation (because the corresponding necessary parameters are already prepared).

When time point T3 is reached, after the second read operation TR2 is completed, the memory controller 210 immediately triggers and executes a third read operation TR3. This continuous mode of operation shows a pipelined data read process, in which the preparation and execution process of each read operation form an efficient overlapping execution mode.

It is worth mentioning that the timing arrangement in FIG. 5 shows an ideal situation, that is, each read operation can be successfully completed. This parallel processing mechanism significantly improves the data read efficiency, because the voltage value and related parameters required for the next read operation can always be prepared before the current read operation is completed. For example, during the period from T1 to T2, the memory controller 210, while executing the first read operation TR1, completes steps CV2 and SR2, so as to ensure that the second read operation TR2 can start execution immediately at time T2.

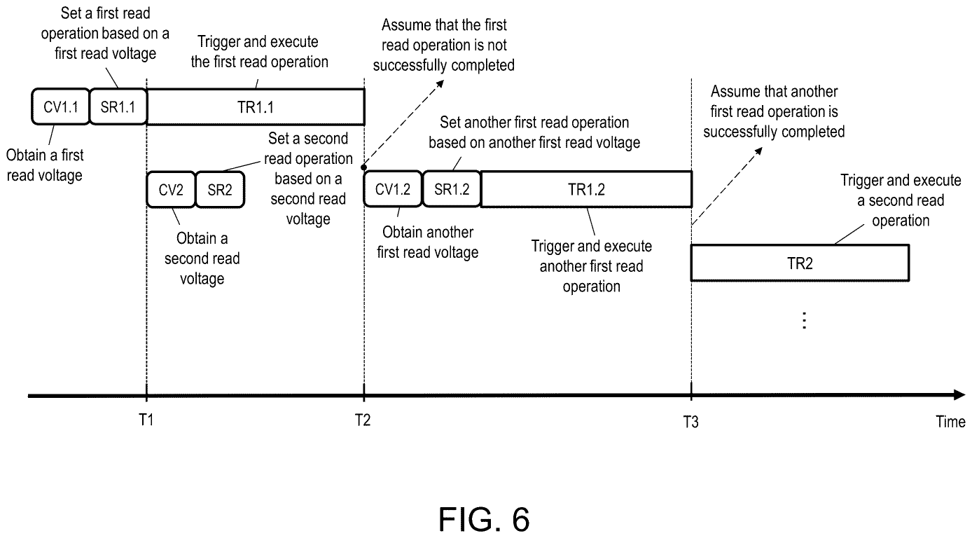

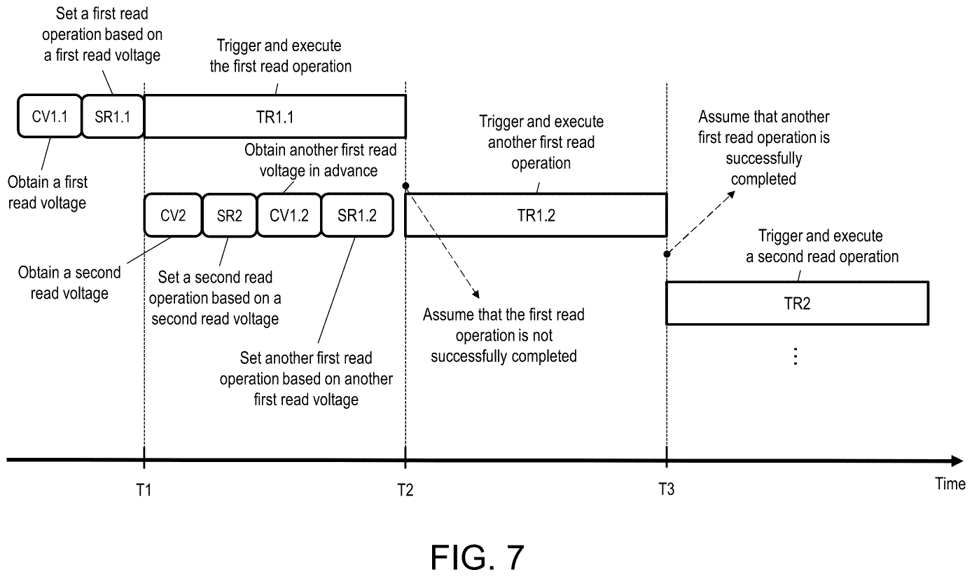

However, in the event that a previous read operation is not successfully completed, the memory management method provided by the present disclosure also has a corresponding execution flow, as described in the corresponding embodiments of FIG. 6 and FIG. 7.

FIG. 6 is a schematic timing diagram of a plurality of data read operations according to another embodiment of the present disclosure.

In another embodiment, referring to FIG. 6, the figure shows a processing flow when the first data read operation fails. In this case, the memory controller 210 takes specific measures to ensure reliable data reading.

For example, at time point T1, the memory controller 210 first executes a step of obtaining a first read voltage (such as step CV1.1), and subsequently, in step SR1.1, sets a first read operation based on the first read voltage. Immediately thereafter, the memory controller 210 triggers and executes a first read operation TR1.1. It is worth noting that, during the execution of the first read operation TR1.1, the memory controller 210 starts to execute step CV2 of obtaining a second read voltage, and in step SR2, sets a second read operation based on the second read voltage, which reflects the parallel processing mechanism of the present disclosure.

Next, at time point T2, after the execution of the first read operation TR1.1 is completed, the memory controller 210 detects that the operation has not been successfully completed. In this case, although the memory controller 210 has already prepared for the second data read operation through steps CV2 and SR2, the memory controller 210 prioritizes handling the read problem of the first data. Therefore, the memory controller 210 immediately executes step CV1.2 of obtaining another first read voltage, and in step SR1.2, sets another first read operation based on the another first read voltage.

This priority processing mechanism is reflected in that the memory controller 210 temporarily shelves the originally planned second data read operation and instead executes another read attempt TR1.2 for the first data. This design ensures that a new read operation is not prematurely started before the current data read problem is solved. It is worth noting that, although the preparation work (CV2 and SR2) for the second data read operation has been completed, its execution is postponed until it is confirmed that the first data can be successfully read.

In addition, at time point T3, the memory controller 210 determines subsequent operations according to the execution result of TR1.2. If the another first read operation TR1.2 still fails, the memory controller 210 may continue to try new voltage values; and if TR1.2 is successfully completed, the previously prepared second data read operation TR2 can be started.

It is worth mentioning that, the timing arrangement in FIG. 6 reflects the flexibility and reliability of the present disclosure in handling read failure situations. By timely adjusting the read strategy and ensuring that the current data read problem is solved, the memory controller 210 can maintain the efficiency of the read operation as much as possible while ensuring data reliability. This mechanism is particularly suitable for application scenarios with high requirements for data integrity, for example, data recovery operations during error handling.

FIG. 7 is a schematic timing diagram of a plurality of data read operations according to yet another embodiment of the present disclosure.

In another embodiment, referring to FIG. 7, the figure shows a data read flow in which the memory controller 210 adopts a preventive preparation mechanism. This embodiment particularly emphasizes that, during the execution of the first data read operation, another set of read parameters that may be needed is prepared in advance, so as to further optimize the time efficiency of the read operation.

Specifically, at time point T1, the memory controller 210 first executes step CV1.1 of obtaining a first read voltage, and in step SR1.1, sets a first read operation based on the voltage. Subsequently, during the execution of the first read operation TR1.1, the memory controller 210 not only executes step CV2 of obtaining a second read voltage and the corresponding setting step SR2, but also executes in advance step CV1.2 of obtaining another first read voltage and the corresponding setting step SR1.2.

In more detail, the advantage of this preventive preparation mechanism is that: when time point T2 is reached, if the first read operation TR1.1 fails, the memory controller 210 can immediately use the already prepared another set of first read parameters to execute another first data read operation TR1.2, without requiring additional parameter preparation time. Compared with the embodiment shown in FIG. 6, this preventive preparation mechanism further reduces the response time in the case of a read failure. That is to say, in the example of FIG. 7, it can be seen that each read operation can be executed continuously and immediately following one another.

At time point T3, if the another first read operation TR1.2 is successfully completed, the memory controller 210 can then directly start executing the second data read operation TR2, which is already prepared. This mechanism ensures that even when multiple attempts are needed to read the first data, subsequent read operations can also be started in a timely manner, so as to maintain the overall read efficiency.

It is worth mentioning that this preventive preparation mechanism is particularly suitable for error handling scenarios. Since it may be necessary to try different read voltages multiple times during the error handling process, preparing the next set of parameters that may be needed in advance can significantly reduce the delay time between each retry. This solution not only improves the response speed of a single read operation, but also improves the overall data read efficiency.

In some embodiments, the memory controller 210 may optimize the parameter selection for preventive preparation based on historical data and error pattern analysis. For example, if historical data shows that certain voltage value combinations are more likely to lead to a successful read, the memory controller 210 may prioritize preparing the parameters corresponding to these voltage values.

In another embodiment, the memory controller 210 (e.g., the integrated read module 300) improves data read efficiency by reasonably utilizing the multi-plane structure of the rewritable non-volatile memory module 220. Specifically, the rewritable non-volatile memory module 220 comprises a plurality of storage planes, and each storage plane is equipped with an independent register set and command queue.

Specifically, when a plurality of data needs to be read, the integrated read module 300 first checks the physical location distribution of this data in the rewritable non-volatile memory module 220. For example, when the integrated read module 300 is preparing to execute the first data read operation, it simultaneously queries the storage location information of the second data. If it is confirmed that the first data and the second data are located in different storage planes, the memory controller 210 can fully utilize the relevant processing resources (e.g., register sets and command queues) of each storage plane to optimize the read process.

In more detail, in an embodiment, this parallel parameter setting comprises, for example:
(1) Register set configuration: The integrated read module 300 can simultaneously write respective required parameters to the register sets of different storage planes. For example, when the first data read operation is using the register set of a first storage plane, the integrated read module 300 can in parallel write parameters such as the voltage value and address information of the second data read operation to the register set of a second storage plane.
(2) Command queue management: The integrated read module 300 can load the command sequence of the second data read operation into the command queue of a second storage plane in advance without interfering with the command queue currently being executed by a first storage plane. These command sequences comprise, for example: a command for setting a read voltage value, a command for setting a target address, a command for preloading a data buffer, and a command for triggering a read operation.
(3) Resource allocation: The integrated read module 300 allocates independent system resources for parallel operations on different storage planes, for example, comprising: respective data buffer spaces, independent status monitoring registers, separate data transmission channels, and dedicated error detection resources.

For example, after confirming that a plurality of data to be read are distributed in different planes, the integrated read module 300 may adopt a further parallel processing strategy. When the first data read operation is being executed, the integrated read module 300 simultaneously performs parameter setting for the read operation of the second data. Since different storage planes have independent register sets and command queues, this parallel parameter setting does not interfere with the ongoing first data read operation. For example, when the first data read operation is using the hardware resources of a first storage plane, the integrated read module 300 can simultaneously use the register set of a second storage plane to prepare the read parameters for the second data.

It is worth mentioning that the independent hardware resources of different storage planes ensure that the two read operations do not interfere with each other. If the memory controller 210 determines that the second data is located in a different storage plane from the first data, it can even trigger the execution of the second data read operation before the first data read operation is completed. For example, during the operation of the first data read operation and after obtaining the second voltage for the second data read operation, the second data read operation can be directly executed without waiting for the completion of the first data read operation, thereby realizing parallel read operations and significantly improve the overall read efficiency. Assuming that another first voltage is also obtained during the execution of the second data read operation, after the first data read operation is completed, another first data read operation can also be directly and subsequently executed based on the another first voltage, using the hardware resources of the first storage plane.

In addition, the memory controller 210 also dynamically manages the resource usage of each storage plane. When it is detected that a certain read operation is about to be completed, the memory controller 210 plans in advance the next read operation that will use that storage plane, ensuring that the hardware resources of the storage plane are fully utilized. This dynamic scheduling mechanism based on storage planes not only improves the overall read efficiency, but also improves the utilization of hardware resources.

In practical applications, the memory controller 210 may maintain a storage plane status table to record in real time information such as the usage status and queue length of each storage plane, in order to better schedule read operations. In addition, it may also, based on factors such as the read frequency and importance of data, consider allocating frequently co-accessed data to different storage planes during data writing, so as to create more efficient operations for subsequent parallel reading.

This embodiment also provides a computer program product, comprising computer-readable code, or a non-volatile computer-readable storage medium carrying computer-readable code, wherein when the computer-readable code runs in a processor, the processor executes the steps of the aforementioned memory management method. The computer program product can be specifically implemented by means of hardware, firmware, software, or a combination thereof. In an optional embodiment, the computer program product is specifically embodied as a computer storage medium, and in another optional embodiment, the computer program product is specifically embodied as a software product, such as a software development kit (SDK), etc.

Based on the above, the memory management method and the memory controller thereof provided by one or more embodiments of the present disclosure improve data read efficiency by using an innovative integrated read module and a corresponding parallel processing mechanism, especially for read operations in an error handling procedure. Specifically, the present disclosure effectively reduces the time overhead required for purely serial processing by overlapping the execution process of the first data read operation with the parameter preparation process of the second data read operation. In addition, the present disclosure adopts the integrated read module to encapsulate a plurality of conventional read steps into a unified interface, which simplifies the operation process of the processor 211 and also improves the maintainability of the code.

Furthermore, the present disclosure also provides a flexible error handling mechanism. When the first data read operation fails, the system can quickly switch to another set of pre-prepared read parameters, which greatly reduces the response time of the retry process. At the same time, the present disclosure makes full use of the multi-plane architecture of the rewritable non-volatile memory module, and by determining the storage plane where the data is located, achieves true parallel data reading under appropriate conditions, further improving the overall performance.

It is particularly worth mentioning that the present disclosure, by coordinating the operation of various functional units through the integrated read module, maximizes the hardware resource efficiency of the storage device while ensuring the reliability of data reading, and also reduces the processing burden of the processor itself. This design not only improves the data read speed during the error handling process, but also provides a new technical idea for the performance integration and optimization of storage devices, and has important practical value.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A memory management method, adapted for a storage device configured with a
rewritable non-volatile memory module, the method comprising:
obtaining a first voltage value of a first data read operation corresponding to first data;
setting the first voltage value and a first read parameter corresponding to the first data to an integrated read module, so as to execute the first data read operation via the integrated read module;
while executing the first data read operation, obtaining in parallel a second voltage value of a second data read operation corresponding to second data; and
in response to completion of the first data read operation, setting the second voltage value and a second read parameter corresponding to the second data to the integrated read module, so as to execute the second data read operation via the integrated read module.

2. The memory management method according to claim 1, wherein the first read parameter comprises one or more of the following:
a target physical address of the first data in the rewritable non-volatile memory module;
a first data length of the first data;
physical page size information of the first data;
a read mode identifier of the first data;
an error detection parameter of the first data; and
metadata of the first data.

3. The memory management method according to claim 1, wherein the method further comprises:
if the first data read operation fails, obtaining another first voltage value for rereading the first data, wherein the another first voltage value is different from the first voltage value; and
setting the another first voltage value and the first read parameter to the integrated read module, so as to re-execute the first data read operation via the integrated read module.

4. The memory management method according to claim 1, wherein, during execution of the first data read operation:
if the first data read operation fails, pausing execution of the second data read operation until the first data read operation is confirmed to be successfully completed.

5. The memory management method according to claim 1, wherein the method further comprises:
storing the first voltage value used each time the first data read operation is executed and a corresponding first read result; and
based on the first voltage value and the first read result, determining an optimal voltage value for reading the first data.

6. The memory management method according to claim 5, wherein determining the optimal voltage value comprises:
recording a plurality of first voltage values and numbers of first read error bits; and
taking a specific first voltage value corresponding to a minimum number of the first read error bits as the optimal voltage value.

7. The memory management method according to claim 1, wherein the integrated read module executing the first data read operation comprises:
based on the first voltage value and the first read parameter, sending a read command sequence to the rewritable non-volatile memory module; and
obtaining the read first data from the rewritable non-volatile memory module.

8. The memory management method according to claim 1, wherein the integrated read module comprises:
a parameter configuration module, for storing the first voltage value and the first read parameter;
a command generation module, for generating a read command sequence for the rewritable non-volatile memory module according to the first voltage value and the first read parameter;
an execution module, for sending the read command sequence to the rewritable non-volatile memory module and receiving the read first data; and
a status feedback module, for storing execution status information of the first data read operation.

9. The memory management method according to claim 1, wherein:
the rewritable non-volatile memory module comprises a plurality of storage planes, and each of the storage planes has a corresponding register set and command queue; and
the integrated read module is configured to, when executing the first data read operation, perform parallel parameter setting for a read operation of the second data located in a different storage plane.

10. The memory management method according to claim 9, wherein the method further comprises:
determining whether the first data and the second data are located in different storage planes; and
in response to the first data and the second data being located in different storage planes, triggering execution of the second data read operation before the first data read operation is completed.

11. A memory controller, for controlling a storage device configured with a rewritable non-volatile memory module, wherein the memory controller comprises:
a memory interface control circuit, for electrically connecting to the rewritable non-volatile memory module; and
a processor, electrically connected to the memory interface control circuit, wherein the processor is further electrically connected to a connection interface circuit of the storage device, so as to be electrically connected to a host system,
wherein the processor is configured to:
obtain a first voltage value of a first data read operation corresponding to first data;
set the first voltage value and a first read parameter corresponding to the first data to an integrated read module, so as to execute the first data read operation via the integrated read module;
while executing the first data read operation, obtain in parallel a second voltage value of a second data read operation corresponding to second data; and
in response to completion of the first data read operation, set the second voltage value and a second read parameter corresponding to the second data to the integrated read module, so as to execute the second data read operation via the integrated read module.

12. The memory controller according to claim 11, wherein the first read parameter comprises one or more of the following:
a target physical address of the first data in the rewritable non-volatile memory module;
a first data length of the first data;
physical page size information of the first data;
a read mode identifier of the first data;
an error detection parameter of the first data; and
metadata of the first data.

13. The memory controller according to claim 11, wherein the processor is further configured to:
if the first data read operation fails, obtain another first voltage value for rereading the first data, wherein the another first voltage value is different from the first voltage value; and
set the another first voltage value and the first read parameter to the integrated read module, so as to re-execute the first data read operation via the integrated read module.

14. The memory controller according to claim 11, wherein the processor is further configured to:
during execution of the first data read operation, if the first data read operation fails, pause execution of the second data read operation until it is confirmed that the first data read operation is successfully completed.

15. The memory controller according to claim 11, wherein the processor is further configured to:
store the first voltage value used each time the first data read operation is executed and a corresponding first read result; and
based on the first voltage value and the first read result, determine an optimal voltage value for reading the first data.

16. The memory controller according to claim 15, wherein determining the optimal voltage value comprises:
recording a plurality of first voltage values and corresponding numbers of first read error bits; and
taking a specific first voltage value corresponding to a minimum number of the first read error bits as the optimal voltage value.

17. The memory controller according to claim 11, wherein a manner in which the processor executes the first data read operation via the integrated read module comprises:
based on the first voltage value and the first read parameter, sending a read command sequence to the rewritable non-volatile memory module; and
obtaining the read first data from the rewritable non-volatile memory module.

18. The memory controller according to claim 11, wherein the integrated read module comprises:
a parameter configuration module, for storing the first voltage value and the first read parameter;
a command generation module, for generating a read command sequence for the rewritable non-volatile memory module according to the first voltage value and the first read parameter;
an execution module, for sending the read command sequence to the rewritable non-volatile memory module and receiving the read first data; and
a status feedback module, for storing execution status information of the first data read operation.

19. The memory controller according to claim 11, wherein:
the rewritable non-volatile memory module comprises a plurality of storage planes, and each of the storage planes has a corresponding register set and command queue; and
the integrated read module is configured to, when executing the first data read operation, perform parallel parameter setting for a read operation of the second data located in a different storage plane.

20. The memory controller according to claim 19, wherein the processor is further configured to:
determine whether the first data and the second data are located in different storage planes; and
in response to the first data and the second data being located in different storage planes, trigger execution of the second data read operation before the first data read operation is completed.
